(19) United States
(12) Patent Application Publication
(10) Pub. No.: US 2016/0159316 A1
(43) Pub. Date: Jun. 9, 2016

(54) VEHICLE AND SAFETY PROTECTION METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventor: ZHI-LONG SHU, Shenzhen (CN)

(21) Appl. No.: 14/584,657

(22) Filed: Dec. 29, 2014

(30) Foreign Application Priority Data
Dec. 3, 2014 (CN) 201410728243.7

(51) Int. Cl. B60R 22/195; B60R 22/46

(52) U.S. Cl. CPC B60R 22/195; B60R 22/46; B60R 2022/4685

(57) ABSTRACT

A method of protecting safety of a driver of a vehicle, the vehicle including a motion sensor, and a seat belt pretensioner of a seat belt is provided. Driving information is obtained from the motion sensor, and a tension value of the seat belt pretensioner is determined according to the driving information. The seat belt pretensioner is controlled to tighten the seat belt with the tension value.

### CROSS-REFERENCE TO RELATED APPLICATIONS

This application claims priority to Chinese Patent Application No. 201410728243.7 filed on Dec. 3, 2014, the contents of which are incorporated by reference herein.

### FIELD

The subject matter herein generally relates to driver safety, and particularly to a vehicle and a method for protecting a driver of the vehicle.

### BACKGROUND

Generally, when a driver is driving a vehicle, external factors such as road conditions may lead to frequent changes in driving speed. Frequent changes of the driving speed may cause the driver to be unsafe.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a vehicle.

FIG. 2 illustrates a flowchart of one embodiment of a method for protecting safety of a driver of the vehicle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

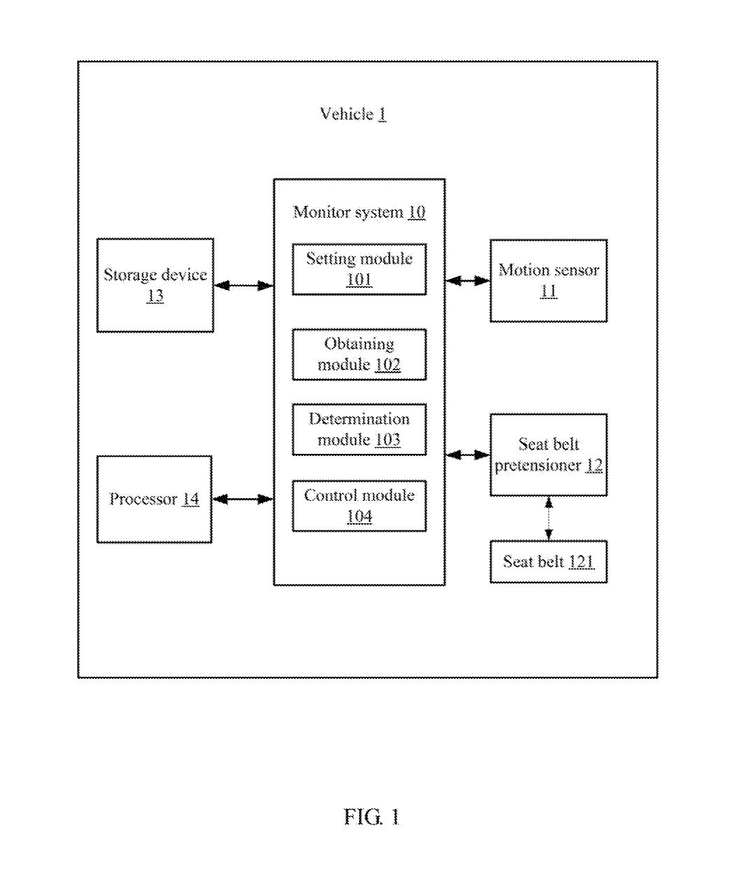

FIG. 1 is a block diagram of one embodiment of a vehicle. Depending on the embodiment, a vehicle 1 includes a monitor system 10, a motion sensor 11, a seat belt pretensioner 12 of a seat belt 121, a storage device 13, and at least one processor 14. FIG. 1 illustrates only one example of the vehicle 1 that can include more or fewer components than illustrated, or have a different configuration of the various components in other embodiments.

The motion sensor 11 is used to detect driving information of the vehicle 1. In one embodiment, the motion sensor 11 is a speed sensor, and the driving information includes, but is not limited to a driving speed of the vehicle 1.

The monitor system 10 is used to ensure safety of a driver when the driver is driving the vehicle 1. In one embodiment, the monitor system 10 protects the driver by controlling the seat belt pretensioner 12 to tighten the seat belt 121 with a predetermined tension value. In one embodiment, the predetermined tension value corresponds to the driving information.

The storage device 13 can be an internal storage device, such as a flash memory, a random access memory (RAM) for temporary storage of information, and/or a read-only memory (ROM) for permanent storage of information. The storage device 13 can also be an external storage device, such as an external hard disk, a storage card, or a data storage medium. The at least one processor 14 can be a central processing unit (CPU), a microprocessor, or other data processor chip that performs functions of the vehicle 1.

In at least one embodiment, the monitor system 10 can include a setting module 101, an obtaining module 102, a determination module 103, and a control module 104. The function modules 101-104 can include computerized codes in the form of one or more programs, which are stored in the storage device 13, and are executed by the at least one processor 14 to provide functions of the present disclosure. Details will be given in the following paragraphs.

The setting module 101 predetermines a plurality of tension values corresponding to different driving information, for the seat belt pretensioner 12. As mentioned above, the driving information includes the driving speed of the vehicle 1. In one embodiment, the setting module 101 can preset a speed range corresponding to each of the plurality of tension values.

For example, the setting module 101 predetermines a first tension value (for example, 0 Newton (N)) for the seat belt pretensioner 12, when the driving speed of the vehicle 1 is less than 50 kilometers per hour (km/h).

For another example, the setting module 101 predetermines a second tension value (for example, 2 N) for the seat belt pretensioner 12, when the driving speed of the vehicle 1 is within a speed range of about 50 km/h to about 80 km/h. The setting module 101 predetermines a third tension value (for example, 4 N) for the seat belt pretensioner 12, when the driving speed of the vehicle 1 is within a speed range of about 80 km/h to about 120 km/h. The setting module 101 further predetermines a fourth tension value (for example, 6 N) for the seat belt pretensioner 12, when the driving speed of the vehicle 1 is greater than 120 km/h.

The obtaining module 102 obtains the driving information from the motion sensor 11. In one embodiment, the motion sensor 11 can be the speed sensor. For example, the obtaining module 102 obtains the driving speed from the motion sensor 11.

The determination module 103 determines a tension value for the seat belt pretensioner 12 according to the driving information. For example, the determination module 103 determines the third tension value (for example, 4 N) for the seat belt pretensioner 12, when the driving speed of the vehicle 1 is within the speed range of about 80 km/h to about 120 km/h.

The control module 104 controls the seat belt pretensioner 12 to tighten the seat belt 121 of the vehicle 1 with the tension value determined by the determination module 103. For example, the control module 104 controls the seat belt pretensioner 12 to tighten the seat belt 121 with the third tension value, when the driving speed of the vehicle 1 is within the speed range of about 80 km/h to about 120 km/h.

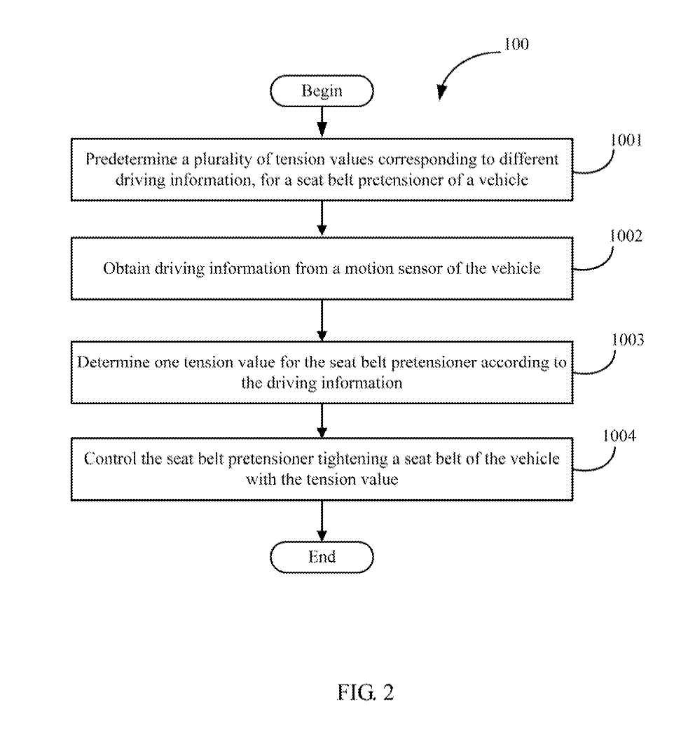

FIG. 2 illustrates a flowchart is presented in accordance with an example embodiment. The example method 100 is provided by way of example, as there are a variety of ways to carry out the method. The method 100 described below can be carried out using the configurations illustrated in FIG. 1, for example, and various elements of these figures are referenced in explaining example method 100. Each block shown in FIG. 2 represents one or more processes, methods or subroutines, carried out in the exemplary method 100. Furthermore, the illustrated order of blocks is by example only and the order of the blocks can be changed according to the present disclosure. The exemplary method 100 can begin at block 1001. Depending on the embodiment, additional steps can be added, others removed, and the ordering of the steps can be changed.

At block 1001, a setting module predetermines a plurality of tension values corresponding to different driving information, for a seat belt pretensioner of a vehicle.

In one embodiment, the driving information includes a driving speed of the vehicle. In one embodiment, the setting module can preset a speed range corresponding to each of the plurality of tension values. For example, the setting module predetermines a first tension value (for example, 0 Newton (N)) for the seat belt pretensioner, when the driving speed of the vehicle is less than 50 kilometers per hour (km/h).

For another example, the setting module predetermines a second tension value (for example, 2 N) for the seat belt pretensioner, when the driving speed of the vehicle is within a speed range of about 50 km/h to about 80 km/h. The setting module predetermines a third tension value (for example, 4 N) for the seat belt pretensioner, when the driving speed of the vehicle is within a speed range of about 80 km/h to about 120 km/h. The setting module further predetermines a fourth tension value (for example, 6 N) for the seat belt pretensioner, when the driving speed of the vehicle is greater than 120 km/h.

At block 1002, an obtaining module obtains the driving information from a motion sensor of the vehicle. In one embodiment, the motion sensor can be a speed sensor. For example, the obtaining module obtains a driving speed from the motion sensor.

At block 1003, a determination module determines a tension value for the seat belt pretensioner according to the driving information. For example, the determination module determines the third tension value (for example, 4 N) for the seat belt pretensioner, when the driving speed of the vehicle is within the speed range of about 80 km/h to about 120 km/h.

At block 1004, a control module controls the seat belt pretensioner to tighten a seat belt of the vehicle with the tension value. For example, the control module controls the seat belt pretensioner to tighten the seat belt with the third tension value, when the driving speed of the vehicle is within the speed range of about 80 km/h to about 120 km/h.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A vehicle comprising:
a motion sensor;
a seat belt pretensioner of a seat belt;
at least one processor; and
a storage device that stores one or more programs, when executed by the at least one processor, causes the at least one processor to:
obtain driving information from the motion sensor;
determine a tension value of the seat belt pretensioner according to the driving information; and
control the seat belt pretensioner to tighten the seat belt with the tension value.

2. The vehicle according to claim 1, wherein the processor further:
predetermines a plurality of tension values corresponding to different driving information, for the seat belt pretensioner.

3. The vehicle according to claim 1, wherein the motion sensor is a speed sensor and the driving information comprises a driving speed of the vehicle.

4. A computer-implemented method for protecting safety of a driver of a vehicle, the vehicle comprising a motion sensor, a seat belt pretensioner of a seat belt, and at least one processor, the method comprising:
obtaining driving information from the motion sensor;
determining a tension value of the seat belt pretensioner according to the driving information; and
controlling the seat belt pretensioner to tighten the seat belt with the tension value.

5. The method according to claim 4, further comprising:
predetermining a plurality of tension values corresponding to different driving information, for the seat belt pretensioner.

6. The method according to claim 4, wherein the motion sensor is a speed sensor and the driving information comprises a driving speed of the vehicle.

7. A non-transitory storage medium having stored thereon instructions that, when executed by a processor of a vehicle, causes the processor to perform a method for protecting safety of a driver of the vehicle, the vehicle comprising a motion sensor, and a seat belt pretensioner of a seat belt, wherein the method comprises:
obtaining driving information from the motion sensor;
determining a tension value of the seat belt pretensioner according to the driving information; and
controlling the seat belt pretensioner to tighten the seat belt with the tension value.

8. The non-transitory storage medium according to claim 7, further comprising:
predetermining a plurality of tension values corresponding to different driving information, for the seat belt pretensioner.

9. The non-transitory storage medium according to claim 7, wherein the motion sensor is a speed sensor and the driving information comprises a driving speed of the vehicle.
